(19) United States
(12) Patent Application Publication
(10) Pub. No.: US 2014/0111815 A1
(43) Pub. Date: Apr. 24, 2014

(54) PRINTING APPARATUS AND METHOD FOR CORRECTING PRINT POSITION DISPLACEMENT

(71) Applicant: CANON KABUSHIKI KAISHA, Tokyo (JP)

(72) Inventors: Minoru Teshigawara, Saitama-shi (JP); Yoshiaki Murayama, Tokyo (JP); Masahiko Umezawa, Kawasaki-shi (JP); Shinsuke Ikegami, Tokyo (JP)

(73) Assignee: CANON KABUSHIKI KAISHA, Tokyo (JP)

(21) Appl. No.: 14/050,791

(22) Filed: Oct. 10, 2013

(30) Foreign Application Priority Data
Oct. 23, 2012 (JP) 2012-233790

(51) Int. Cl. G06K 15/10

(52) U.S. Cl. CPC G06K 15/10; G06K 15/102
USPC 358/1.5

(57) ABSTRACT

A printing apparatus which uses a plurality of print element arrays in each of which a plurality of print elements are arranged, and drives a predetermined number of print elements of each of blocks obtained by dividing each of the plurality of the print element arrays into pieces of the predetermined number of the print elements respectively in a time division driving manner, to perform printing on a print medium conveyed, including: a position displacement detecting unit configured to detect print position displacements; and a correction unit configured to perform correction in which pixels which are to be printed by print elements is shifted, the number of the print elements corresponding to an amount of the print position displacement, by a block in each of the plurality of the print element arrays.

### BACKGROUND OF THE INVENTION

1. Field of the Invention

The present invention relates to a printing apparatus and a method for correcting print position displacement. In particular, the present invention relates to a technique of correcting a print position displacement at the time of printing an image on a continuous paper as a print medium by a print head in which a plurality of print element arrays, which extend in a width direction of the continuous paper and in each of which print elements such as nozzles are arranged, are arranged in a conveying direction of the continuous paper.

2. Description of the Related Art

In a printing apparatus, there are some cases where a print position on the print medium is displaced depending upon a change of a positional relation of the print element array to the print medium, and thereby a quality of a print image is degraded. Japanese Patent Laid-Open No. 2009-006676 describes a method for correcting a print position displacement of a dot formed with ink. The print position displacement is caused in a case that in a serial type of printing apparatus, a print head is installed to be inclined.

The printing apparatus described in Japanese Patent Laid-Open No. 2009-006676 obtains information relating to the inclination of the nozzle array in the print head with respect to the main scan direction. Then, this printing apparatus shifts pixels to which dots are to be printed in number corresponding to the inclination, by a block that is defined in a time division driving method for a print head, among an array of ink dots which can be printed by one nozzle array based on the obtained information. Thereby the print position displacement is corrected.

The printing apparatus described in Japanese Patent Laid-Open No. 2009-006676 corrects the print position displacement due to the inclination of the print head caused when installing the print head to the printing apparatus. In this case, since a change of the inclination of the print head accompanying the subsequent print operation is small, the necessity of frequently changing a correction value that has been set once is relatively low.

On the other hand, in a full line type of printing apparatus in which a print medium is conveyed to a print head and a print is performed on the conveyed print medium, there are some cases where a positional relation of each of print element arrays arranged in the conveying direction of the print medium changes due to a change in conveyance accuracy of a conveying amount of the print medium and the like. Therefore, when the correction value that has been set once is used as it is, there is a possibility that the print position of the dot can not be corrected to an appropriate print position.

### SUMMARY OF THE INVENTION

The present invention provides a printing apparatus and a method for correcting print position displacement that can appropriately correct a print position displacement regardless of a change in conveyance accuracy of a print medium.

In a first aspect of the present invention, there is provided a printing apparatus which uses a plurality of print element arrays in each of which a plurality of print elements are arranged, and drives a predetermined number of print elements of each of blocks that are obtained by dividing each of the plurality of the print element arrays into pieces of the predetermined number of the print elements respectively in a time division driving manner, to perform printing on a print medium that is conveyed, said printing apparatus comprising:

a position displacement detecting unit configured to detect print position displacements of the plurality of the print element arrays from each other; and

a correction unit configured to perform correction in which pixels which are to be printed by print elements is shifted, the number of the print elements corresponding to an amount of the print position displacement, by a block in each of the plurality of the print element arrays.

In a second aspect of the present invention, there is provided a method for correcting print position displacement in a printing apparatus which uses a plurality of print element arrays in each of which a plurality of print elements are arranged, and drives a predetermined number of print elements of each of blocks that are obtained by dividing each of the plurality of the print element arrays into pieces of the predetermined number of the print elements respectively in a time division driving manner, to perform printing on a print medium that is conveyed, said method comprising:

a position displacement detecting step for detecting print position displacements of the plurality of the print element arrays from each other; and

a correction step for performing correction in which pixels which are to be printed by print elements is shifted, the number of the print elements corresponding to an amount of the print position displacement, by a block in each of the plurality of the print element arrays.

According to the above-mentioned configuration, the print position displacement can appropriately be corrected regardless of a change in conveyance accuracy of the print medium.

Further features of the present invention will become apparent from the following description of exemplary embodiments (with reference to the attached drawings).

### BRIEF DESCRIPTION OF THE DRAWINGS

FIG. 1 is an appearance diagram showing an inkjet printing apparatus;

FIG. 2 is a cross section showing the internal configuration of the inkjet printing apparatus;

FIG. 3 is an outline diagram showing a relation of relative movement between print heads and a print medium;

FIG. 4A is a diagram showing the configuration of a nozzle surface;

FIG. 4B is a diagram showing the configuration of a nozzle array;

FIG. 5 is a block diagram showing a control system of the inkjet printing apparatus;

FIG. 6 is a block diagram showing an engine control unit;

FIG. 7 is a diagram showing the configuration of a third print memory shown in FIG. 6;

FIG. 8 is a pattern diagram showing the arrangement of print data in a RAM or an HDD shown in FIG. 5;

FIG. 9 is a diagram showing an example of data in a block drive order data memory showing in FIG. 6;

FIG. 10 is a drive circuit diagram for driving the print head;

FIG. 11 is a diagram showing drive timing of a block enabling signal;

FIG. 12 is pattern diagrams each showing the arrangement of images to be printed by each of the print heads;

FIG. 13 is pattern diagrams each showing print data of each of the print heads to which null data is in advance added;

FIG. 14 is diagrams each showing print timing in the state shown in FIG. 13;

FIG. 15A is a pattern diagram showing a print in a case where a conveying amount is short;

FIG. 15B is a pattern diagram showing a print in a case where a conveying amount is short;

FIG. 15C is a pattern diagram showing a print in a case where a conveying amount is short;

FIG. 15D is a pattern diagram showing a print in a case where a conveying amount is short;

FIG. 16 is pattern diagrams each showing a case of correcting the state shown in each of FIG. 15A to FIG. 15D;

FIG. 17A is a pattern diagram showing images and non-images on the print medium;

FIG. 17B is a pattern diagram showing dots;

FIG. 18A is a pattern diagram showing a case where dots are printed earlier by one-half of a pixel;

FIG. 18B is a pattern diagram showing the arrangement of dots in a state of correcting the state shown in FIG. 18A;

FIG. 19A is a pattern diagram showing a case where dots are printed later by one-half of a pixel;

FIG. 19B is a pattern diagram showing the arrangement of dots in a process of correcting the state shown in FIG. 19A;

FIG. 19C is a pattern diagram showing the arrangement of dots in a state of correcting the state shown in FIG. 19A;

FIG. 20A is a pattern diagram showing the detection pattern applied in the black image data;

FIG. 20B is a pattern diagram showing the detection pattern applied in the cyan image data;

FIG. 20C is a pattern diagram showing the detection pattern applied in the magenta image data; and

FIG. 20D is a pattern diagram showing the detection pattern applied in the Yellow image data.

### DESCRIPTION OF THE EMBODIMENTS

Hereinafter, embodiments according to the present invention will in detail be explained with reference to the accompanying drawings.

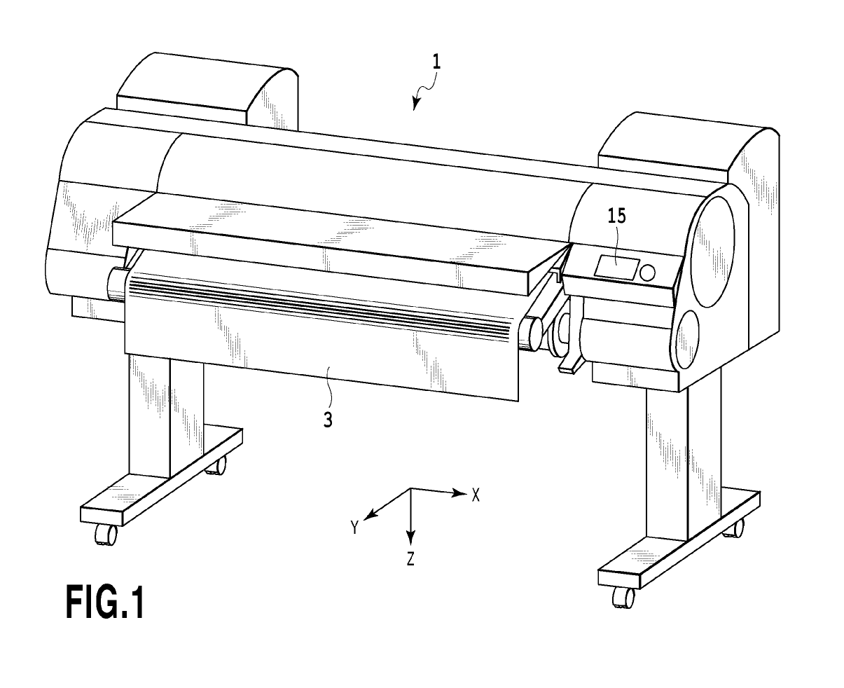

FIG. 1 is an appearance diagram showing an inkjet printing apparatus 1 (hereinafter, called “printing apparatus 1”) according to the present embodiment. A print medium 3 held in a roll shape in the printing apparatus 1 is fed to a printing unit 5 to be described later (pattern printing unit and printing step), and after that, a print is performed on the print medium 3 according to print data. The print medium 3 after printed is pulled out in the Y direction as shown in the figure. A user can perform input of various commands to the printing apparatus 1, such as size designation of the print medium 3 and switch of on-line/off-line by using various switches provided in an operation unit 15.

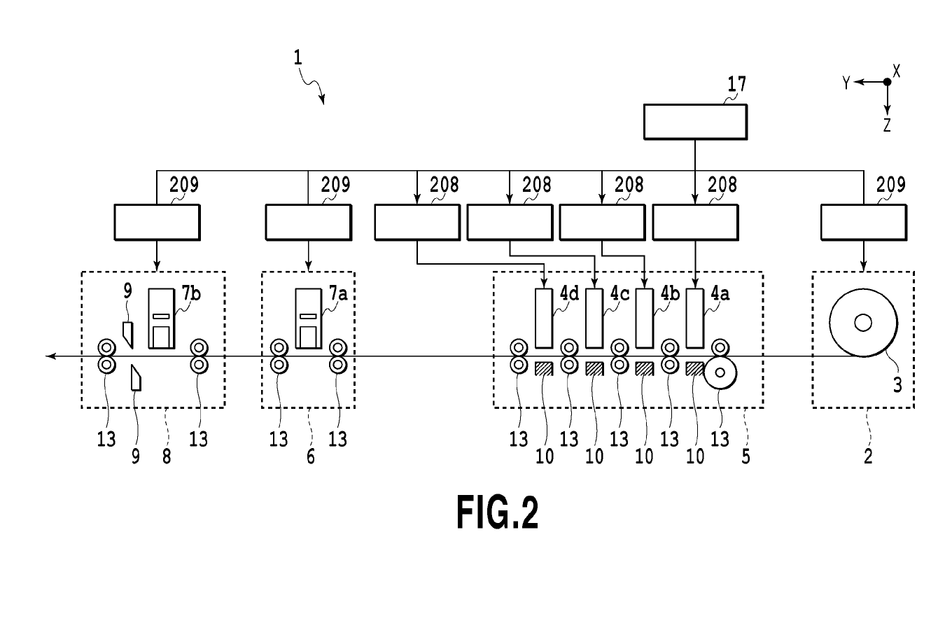

FIG. 2 is a cross section showing the internal configuration of the printing apparatus 1. As shown in this figure, the printing apparatus 1 is provided with a feeding unit 2, a printing unit 5, an inspection unit 6, and a cutting unit 8. In the present embodiment, the feeding unit 2 pulls out the print medium 3 held in a roll shape, and supplies the print medium 3 to the printing unit 5 arranged downstream of the feeding unit 2 in the conveying direction.

The printing unit 5 prints an image on the print medium 3 conveyed from the feeding unit 2, and prints a detection pattern, which has no relationship to the image to be printed, at predetermined timing. An image area for printing an image is defined on the print medium 3 as a roll paper corresponding to a size of the image to be printed, and a print is performed to the image area according to print data. This image area is continuously defined through an area (non-image area), on which an image is not printed, having a predetermined length in the conveying direction.

As described later, the detection pattern is printed on the non-image area. A displacement amount of the print position is detected based upon the detection result of this detection pattern. The printing unit 5 also prints a cut mark pattern as a mark for cutting the print medium 3 to a predetermined size, a flashing pattern for maintaining an ejection state of a nozzle, a nozzle inspection pattern, and the like.

It should be noted that there are some cases where the pattern for detecting the displacement amount of the print position is printed to be combined with a pattern having the other function. For example, when there is a part, which is not necessary for detection of the cut mark pattern, within a print area of the cut mark pattern, in some cases a detection pattern for inspecting a displacement amount of the print position is printed on that part. In this way, the non-image area can be reduced by laying out a plurality of patterns to efficiently use the space.

The printing unit 5 includes print heads 4a to 4d for ejecting inks of different colors, and each of the print heads 4a to 4d is provided with nozzle arrays in each of which nozzles as print elements are arranged along the width direction of the print medium 3. In each of the print heads, a plurality of the nozzle arrays (print element arrays) are arranged in the conveying direction of the print medium 3. Each nozzle array is configured of a plurality of nozzles that can eject ink, and a print is performed on the print medium 3 by ejecting the ink from the plurality of the nozzles. The details of the print heads 4a to 4d will be described later.

The printing unit 5 is provided with conveying mechanisms 13 for conveying the print medium 3. The conveying mechanism 13 includes a plurality of a pair of conveying rollers, which support the print medium 3 between the conveying rollers each. A platen 10 is arranged between one pair of conveying rollers and the other pair of conveying rollers, which has a support surface for supporting the print medium 3 from the backside of a print surface of the print medium 3 at printing. Similar conveying mechanisms 13 are provided also in the inspection unit 6 and in the cutting unit 8. In addition, the print heads 4a to 4d, the conveying mechanisms 13 and the platens 10 are accommodated in the housing.

The inspection unit 6 has a scanner 7a, and reads in the image and the detection pattern printed by the printing unit 5 with this scanner 7a. The read information is sent to a controller 17. The controller 17 determines an ejection state of each nozzle in the print heads 4a to 4d, a conveying state of the print medium 3, the print position, and the like from this information.

The scanner 7a includes a light emitting unit and an imaging element (any thereof is not shown). The light emitting unit is arranged in a position of emitting light toward the reading direction of the imaging element or in a position of emitting light toward the imaging element in a state of interposing the print medium 3 between the imaging elements. In the former case, the imaging element receives reflected light of the light emitted from the light emitting unit, and in the latter case, the imaging element receives light transmitting through the print medium 3 among the lights emitted from the light emitting unit. The imaging element converts the received light into an electrical signal, and outputs the electrical signal.

As the imaging element, a charge coupled devices (CCD) image sensor, a complementary metal oxide semiconductor (CMOS) image sensor or the like may be used.

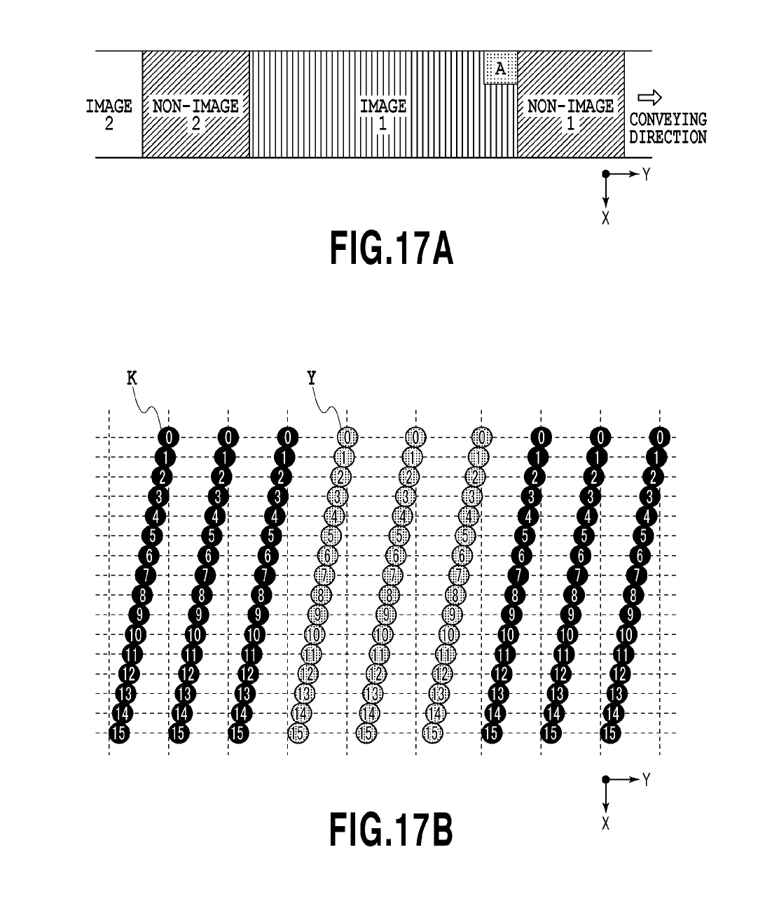

In the present embodiment, a detection pattern having no relation to an image to be printed is printed on a non-image area of the print medium 3 in the printing unit 5. This detection pattern is read by the inspection unit 6 to be analyzed, thereby making it possible to measure a print position displacement amount of the nozzle arrays in the respective print heads 4a to 4d. The correction to the print position displacement is performed at a resolution of one pixel or less based upon the measurement result as described later with reference to FIG. 17 and the subsequent figures.

In the present embodiment, the print and the detection of the detection pattern are performed for each time the non-image area faces the print head. That is, when the print on the image area is finished, a detection pattern is printed on a non-image area adjacent to that image area, and is specified. The correction of the print position displacements of the print heads is performed based upon the measurement result, which is reflected to a print on the next image area.

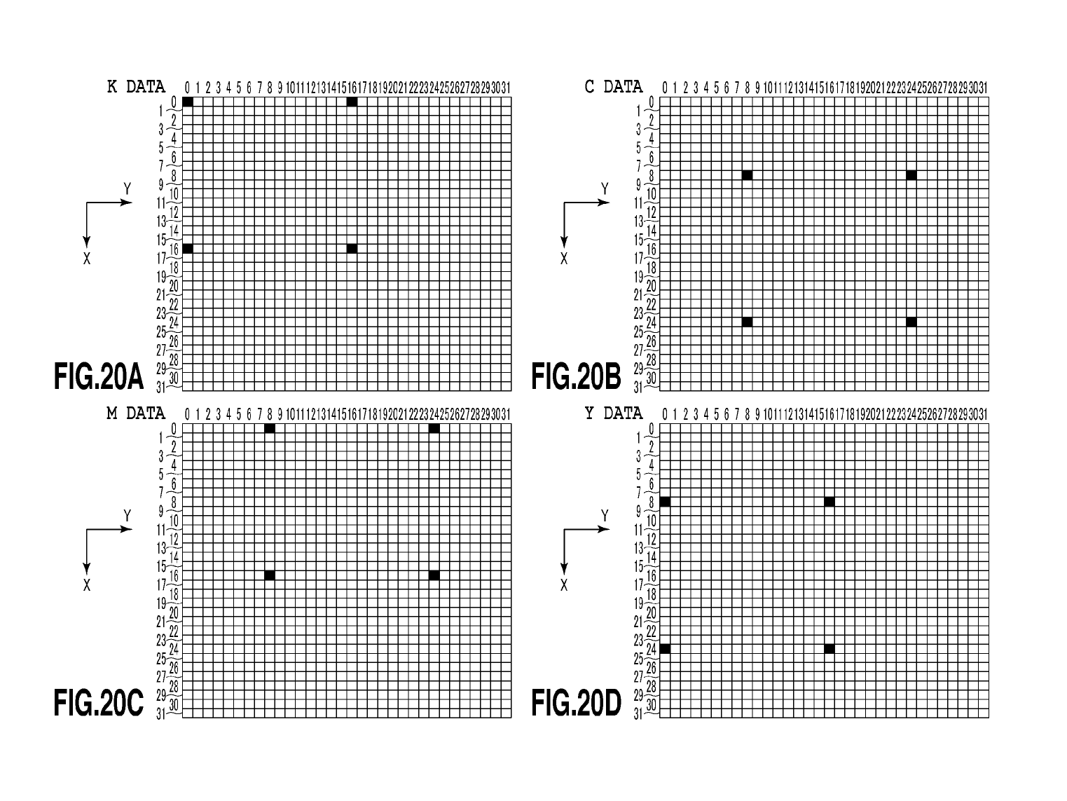

It should be noted that the print and the detection of the detection pattern may be performed on each non-image area each time as in the case of the above-mentioned example, or may be performed for the predetermined number of the non-image areas respectively. In addition, the position displacement amount may be determined by one time of the measurement result or may be determined by measuring the position displacement amount by plural times and calculating, for example, averaging the result. The detection pattern may be printed on an image area. The detection pattern may be dot pattern as shown in FIG. 20A to FIG. 20D. FIG. 20A to FIG. 20D are a pattern diagram showing the detection pattern applied in the image. The dot pattern forms the dot at the predetermined position. The dot pattern is embedded in the image. The relative position displacement may be calculated by detecting the dot pattern by the inspection unit 6. The dot pattern may be embedded in the image, or may be used also as the image.

The cutting unit 8 has a scanner 7b and a pair of cutting mechanisms 9. The scanner 7b has the same configuration as that of the above-mentioned scanner 7a. The pair of the cutting mechanisms 9 cut the print medium 3. The scanner 7b reads in a cut mark pattern printed on the print medium 3 by the printing unit 5 to confirm the cutting position, and the cutting mechanisms 9 put the print medium 3 therebetween, and cut the print medium 3.

After that, the print medium 3 is conveyed to a drying unit (not shown), wherein the ink printed on the print medium 3 is dried. The drying unit dries the ink printed on the print medium 3 by adopting a method directing a hot air on the print medium 3, a method emitting an electromagnetic wave (ultraviolet rays or infrared rays) on the print medium 3 or the like. In addition, the print medium 3 dried by the drying unit is discharged from a discharging unit (not shown).

In this way, an output matter on which the image is printed can be obtained through the conveying, printing, inspecting, cutting, drying and discharging processes of the print medium 3. The operations as described above will be controlled by the controller 17 to be described later.

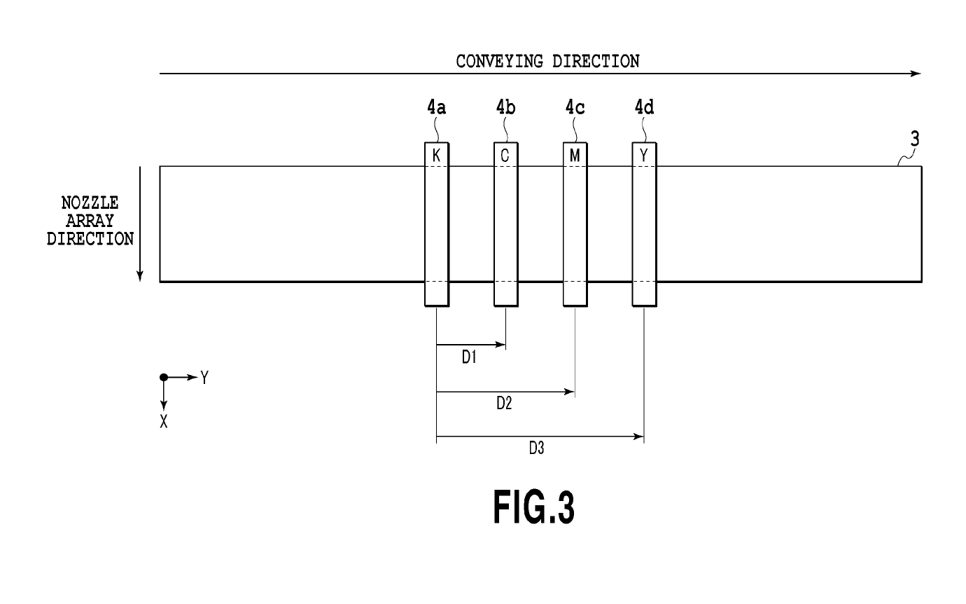

Next, the print heads 4a to 4d will be explained. FIG. 3 is an outline diagram showing a relation of relative movement between the print heads 4a to 4d and the print head 3, and is a top diagram showing the vicinity of the printing unit 5 in FIG. 2. A full line type of the print heads 4a to 4d are provided in the printing apparatus 1, which are respectively arranged to cover the print medium 3 in the width direction. As shown in FIG. 3, the print heads 4a to 4d are provided along the conveying direction of the print medium 3, and the print head 4a, the print head 4b, the print head 4c, and the print head 4d are arranged in that order from the upstream side in the conveying direction. In the present embodiment, images are printed on the print medium 3 in the arrangement order of the print heads 4a to 4d.

As will be described later in details, the nozzle arrays each of which is consisted of a plurality of nozzles are provided in each of the print heads 4a to 4d on a surface (nozzle surface) thereof directed toward the print medium 3. Each nozzle array is configured such that the plurality of the nozzles is arranged in the main scan direction crossing the conveying direction of the print medium 3. Each nozzle is configured of an ejection opening, a flow passage communicated with the ejection opening, and an ejection energy generating element. In regard to the ejection method of ink, a method using a heater element, a method using a piezo element, a method using an electrostatic element, a method using a micro electro mechanical systems (MEMS) element or the like may be adopted.

In the present embodiment, the heater element (heater) is used as the ejection energy generating element. The heater element generates heat by supplying power thereto, and generates foams of a liquid (ink) by the heat generation to eject the liquid (ink) from the ejection opening by the foam-generating energy. The ejected ink droplet is applied to the print medium to form dots on the print medium, and the dots form an image to perform a print on the print medium.

Ink tanks (not show) are respectively connected to the print heads 4a to 4d in such a manner as to be able to supply the corresponding inks thereto respectively. Each of the inks is supplied from the corresponding ink tank to each of the print heads 4a to 4d through an ink tube (not shown). Black ink (K) is ejected from the nozzles of the print head 4a, cyan ink (C) is ejected from the nozzles of the print head 4b, magenta ink (M) is ejected from the nozzles of the print head 4c, and yellow ink (Y) is ejected from the nozzles of the print head 4d respectively.

In the present embodiment, the four print heads 4a to 4d corresponding to inks of four colors composed of KCMY are provided, but the color number of the inks and the number of print heads are not limited thereto. In the present embodiment, a length of each of the print heads 4a to 4d in the main scan direction is a width of 12 inches. However, the length of the print head in the main scan direction that can be used in the present invention is not limited thereto.

In FIG. 3, Distances D1 to D3 represents print position displacements (distances between dots) with respect to the printing medium 3 for the nozzle arrays of the print heads when dots were ejected at the same timing. This data is appropriately detected through the inspection unit 6, and is in advance stored in a predetermined memory (a ROM 202 or an HDD 204 to be described later). The position displacement between the respective nozzle arrays is generated subject to influences not only by an interval between the nozzle arrays of the print heads 4a to 4d, but also by an ejection angle of each of the print heads 4a to 4d, time required from ejection of ink to application of the ink to the print medium 3, variations in conveying amount of the print medium 3, and the like.

Therefore considering these corresponding relations, the print position displacement between the print head 4a and the print head 4b is set to distance D1, the print position displacement between the print head 4a and the print head 4c is set to distance D2, and the print position displacement between the print head 4a and the print head 4d is set to distance D3. At the time of actually performing a print on the print medium 3, the timing for ejecting ink is corrected considering the distances D1 to D3.

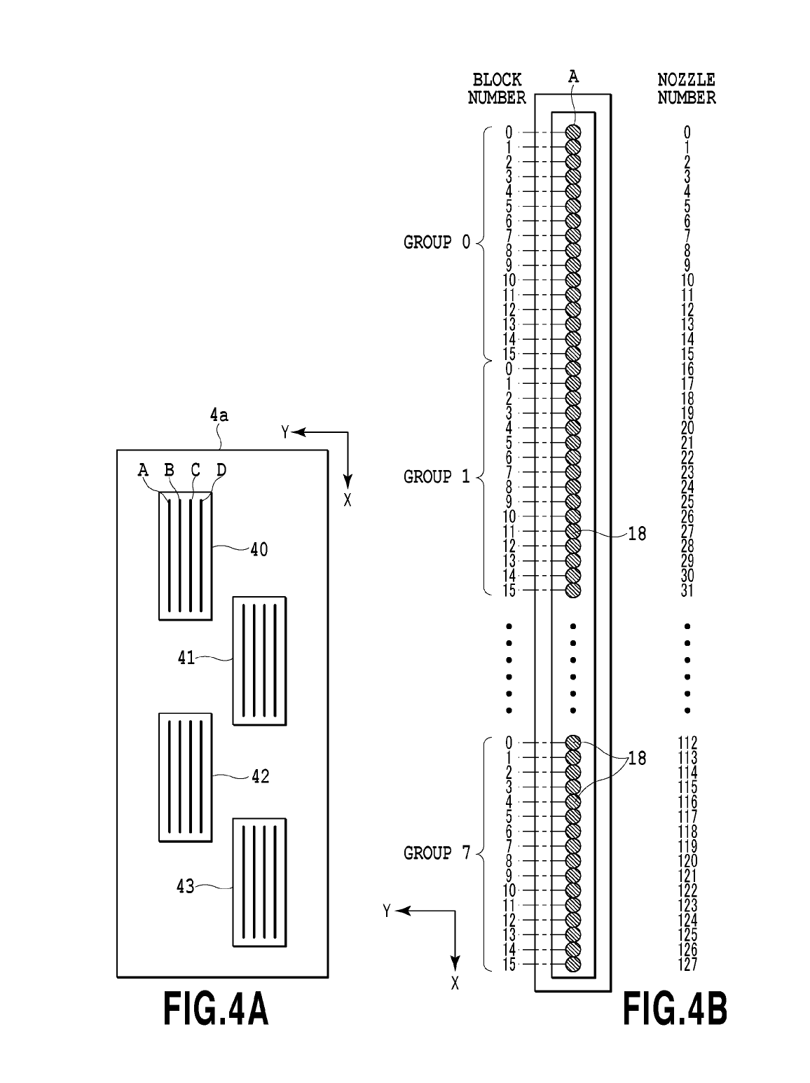

FIG. 4A and FIG. 4B are diagrams each showing a nozzle surface and nozzle arrays of the print head 4a. In FIG. 4A and FIG. 4B, only the print head 4a among the four print heads 4a to 4d shown in FIG. 2 is shown for convenience of explanation, but each of the other print heads 4b to 4d has the similar configuration.

FIG. 4A is a diagram showing the nozzle surface of the print head 4a. As shown in this figure, substrates 40 to 43 are provided in the print head 4a, each having four nozzle arrays (nozzle array A to nozzle array D). The substrates 40 to 43 are arranged on the print head 4a in a zigzag manner. The substrate 40 is arranged to overlap the substrate 41, the substrate 41 is arranged to overlap the substrate 42, and the substrate 42 is arranged to overlap the substrate 43 respectively. In addition, each of the substrates 40 to 43 has a length of one inch in the X direction.

It should be noted that in the present embodiment, the respective nozzle arrays are arranged in a zigzag manner, but nozzles constituting the nozzle array may be arranged across the entire print medium 3 in the width direction.

FIG. 4B is a diagram showing the nozzle array A of the print head 4a. In this figure, only the nozzle array A is shown, but each of the other nozzle arrays has the similar configuration. As shown in this figure, the nozzle array A is consisted of 128 pieces of nozzles 18. The nozzle numbers of 0 to 127 are virtually attached to the respective nozzles. In addition, the nozzles 18 are classified into eight groups composed of group 0 to group 7 each having 16 pieces of nozzles. In each group, the ejection energy generating elements are assigned to block 0 to block 15 in the order of the smaller nozzle number corresponding thereto.

The ejection energy generating elements assigned to the block numbers are selected by time division, and an image is printed by driving the selected ejection energy generating elements (time division drive). In the present embodiment, a case where the nozzles of the nozzle number 0 to the nozzle number 15 are used to form dots of three columns composed of a first column to a third column for printing an image will be explained as an example.

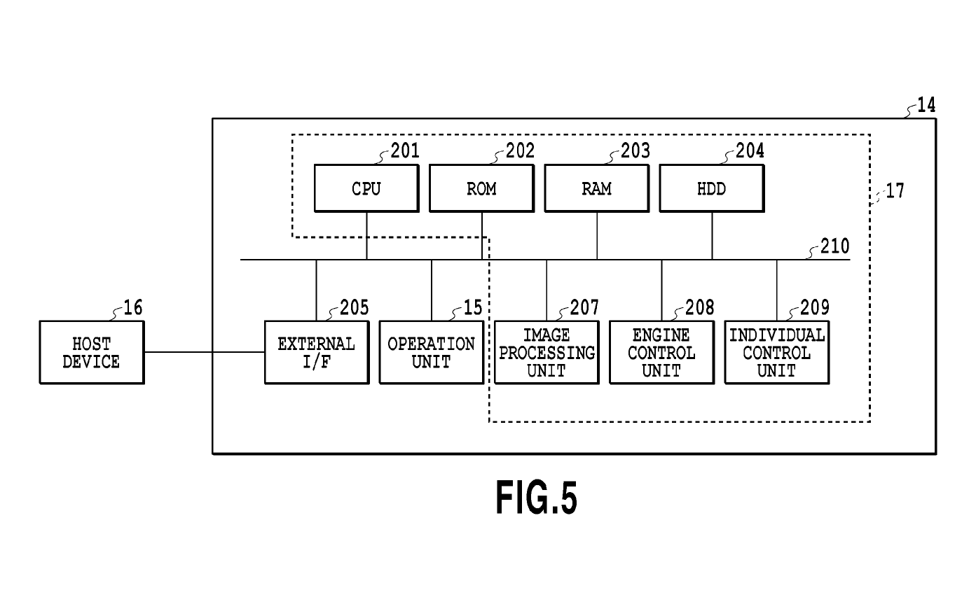

FIG. 5 is a block diagram showing a control system of the printing apparatus 1. As shown in this figure, a control unit 14 is connected to a host device 16 through an external interface 205. In addition, the control unit 14 includes the external interface 205, and besides, the operation unit 15, and the controller 17. The controller 17 controls the feeding unit 2, the printing unit 5, the inspection unit 6, the cutting unit 8, the conveying mechanism 13, and the like through an engine control unit 208 and an individual control unit 209.

As shown in FIG. 5, the controller 17 includes a CPU 201, a ROM 202, a RAM 203, an HDD 204, an image processing unit 207, the engine control unit 208, and the individual control unit 209.

The CPU 201 executes various kinds of programs for integrally controlling various kinds of operations. The ROM 202 stores therein the various kinds of the programs executed by the CPU 201 and fixed data required for the various kinds of the operations in the printing apparatus 1. The RAM 203 is used as a work area of the CPU 201 and a temporal storage area of various kinds of received data. In addition, the RAM 203 stores therein various kinds of setting data. The HDD 204 stores therein various kinds of programs, print data, and setting information required for various kinds of operations of the printing apparatus 1.

The image processing unit 207 executes an image process of image data received from the host device 16, and generates printable print data by the print heads 4a to 4d. Specifically the image processing unit 207 executes a color conversion process and a quantization process to the input image data. In addition, the image processing unit 207 executes resolution conversion, image analysis, image correction, and the like as needed. The print data obtained by these image processes is stored in the RAM 203 or the HDD 204.

The engine control unit 208 controls drive of the print heads 4a to 4d in the printing unit 5 according to the print data based upon a control command received from the CPU 201 and the like. In addition, the engine control unit 208 controls the conveying mechanism 13 and the like. The details of the internal configuration of the engine control unit 208 will be described later. The individual control unit 209 is a sub-controller for driving the feeding unit 2, the inspection unit 6, the cutting unit 8, the drying unit, and the discharging unit respectively based upon the control command from the CPU 201.

The operation unit 15 is an input/output interface to a user. The operation unit 15 includes an input part and an output part. The input part includes a hard key, a touch panel and the like, and receives instructions from a user. The output part is a display, a voice generating device or the like, and displays or outputs information to convey the information to the user. The external interface 205 is an interface for connecting the controller 17 to the host device 16. The above-mentioned configurations are connected through a system bus 210.

The host device 16 is a supply source of image data. The printing apparatus 1 performs a print to the print medium 3 based upon the image data supplied from the hot device 16 to obtain an output matter. The host device 16 may be a general-purpose device of a computer or the like, may be a device exclusive for an image, such as an image capture, a digital camera, or a photo storage, which has an image reading unit. In a case where the host device 16 is the computer, it is necessary for an operation system, application software, and a printer driver for the printing apparatus 1 to be installed in a memory device in the computer.

It should be noted that it is not necessarily required to realize all the above-mentioned processes with the software, and a part or all thereof may be realized by hardware.

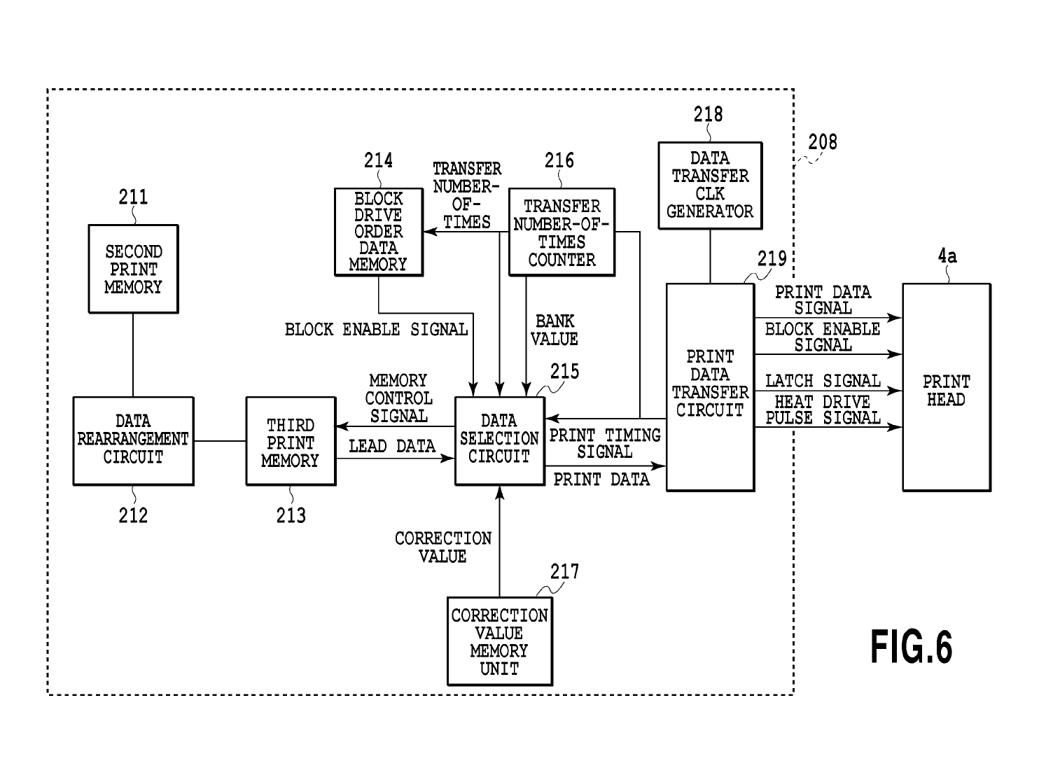

FIG. 6 is a block diagram of the engine control unit 208. As shown in this figure, the engine control unit 208 sends various kinds of signals to the print head 4a. In more detail, the engine control unit 208 sends a print data signal, a block enable signal, a latch signal, and a heat drive pulse signal to the print head 4a. These signals are sent from a print data transfer circuit 219 in the engine control unit 208 to the print head 4a. It should be noted that in this figure, only the print head 4a is illustrated, but the signals are similarly sent to the print heads 4b to 4d.

As shown in FIG. 6, the engine control unit 208 includes, in addition to the print data transfer circuit 219, a data transfer CLK generator 218, a correction value memory unit 217, a transfer number-of-times counter 216, a data selection circuit 215, a block drive order data memory 214, and a third print memory 213. In addition, as shown in this figure, the engine control unit 208 includes a data rearrangement circuit 212 and a second print memory 211.

Image data in a raster unit sent from the host device 16 shown in FIG. 5 are first stored in a reception buffer. This image data is compressed for reducing a sending amount from the host device 16, and after the decompression, is stored in the RAM 203 or the HDD 204. The image data stored in the RAM 203 or the HDD 204 is subject to various kinds of processes, and thereafter, is stored in the second print memory 211 shown in FIG. 6.

The data rearrangement circuit 212 is a circuit for rearrangement the print data. The data rearrangement circuit 212 collects up the print data retained in the second print memory 211 associated with 128 pieces of nozzles as print data of 7 bits for each block to be printed simultaneously to be written in the third print memory 213.

The transfer number-of-times counter 216 is a counter circuit for counting the number-of-times of print timing signals. This number-of-times is incremented for each print timing signal. The transfer number-of-times counter 216 counts from 0 to 15, and returns back to 0. The transfer number-of-times counter 216 counts a Bank value of the third print memory 213, and when the transfer number-of-times counter 216 counts 16 times, the Bank value is incremented by +1.

In the block drive order data memory 214, the order of driving the ejection energy generating elements of block numbers 0 to 15 that are divided into 16 pieces is stored in address 0 to address 15. For example, in a case of driving the ejection energy generating elements in turn from block number 0, the block numbers are stored in the order of 0→1→2→3 . . . from address 0 to address 15.

The print data transfer circuit 219 performs increment of the transfer number-of-times counter 216 in response to a print timing signal generated based upon an optical linear encoder as a trigger, for example. The data selection circuit 215 reads out print data corresponding to a value of the block drive order data memory 214 and a Bank value counted by the transfer number-of-times counter 216 from the third print memory 213 in response to the print timing signal as a starting point.

In addition, the print data is corrected depending on a correction value retained in the correction value memory unit 217. The corrected print data is transferred to the print head 4a in synchronization with a data transfer CLK signal (HD_CLK) generated by the data transfer CLK generator 218.

The data selection circuit 215 reads out block data set to the address of the block drive order data memory 214 in response to a print timing signal as a trigger, reads out the print data corresponding to this block data from the third print memory 213, and transfers the read print data to the print head 4a. The details thereof will be described later.

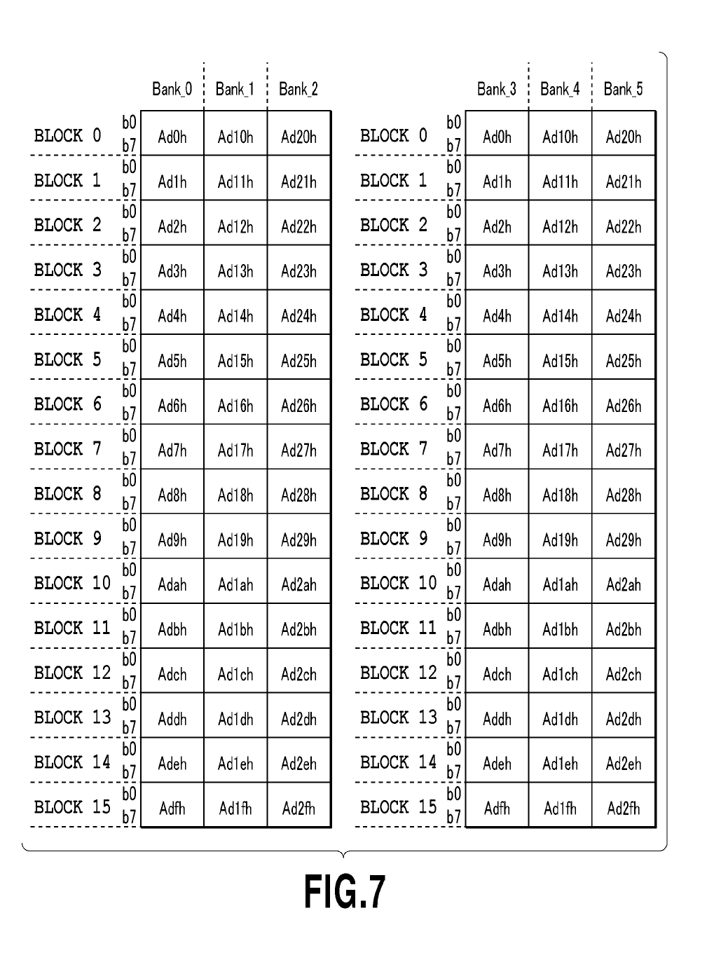

FIG. 7 is a diagram showing the configuration of the third print memory 213 shown in FIG. 6. As shown in this figure, in the third print memory 213 the print data from block 0 to block 15 is in turn retained in address 0 to address F. The data from group 0 to group 7 respectively is retained in block 0 to block 15. In addition, the third print memory 213 is configured of three Banks, each Bank having data of 16 blocks in such a manner that the writing-in operation has an exclusion relation to the reading-in operation.

When Bank 0 is used for writing-in, the reading-in is performed from Bank 1 and Bank 2. In addition, when Bank 1 is used for writing-in, the reading-in is performed from Bank 2 and Bank 0, and when Bank 2 is used for writing-in, the reading-in is performed from Bank 0 and Bank 1.

In the present embodiment, the third print memory 213 is composed of a double buffer configuration, and includes Bank 3 to Bank 5 that are composed of the same configurations as those of Bank 0 to Bank 2. One is used for setting parameters required at the print-starting of the print medium 3, and the other is used for switching to a non-image between images in the middle of performing a print on the print medium 3.

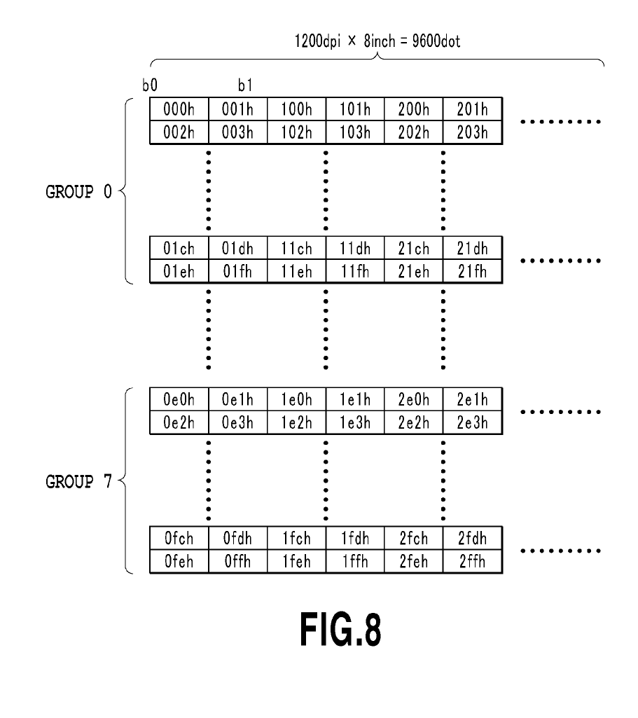

FIG. 8 diagrammatically shows the arrangement of print data in the RAM 203 or the HDD 204 shown in FIG. 5. The print data stored in the RAM 203 or the HDD 204 is vertically associated by addresses 000 to 0FE corresponding to 128 pieces of nozzles. In addition, the RAM 203 or the HDD 204 corresponds laterally to print resolution×size of print medium, and for example, in a case where the print resolution is 1200 dpi and a size of the print medium is eight inches, has a memory area sized to be able to print data of 9600 dots.

In this figure, the print data of the nozzle having nozzle number 0 is retained in b0 of address 000. In addition, the print data in the next column of nozzle number 0 is retained in b1 of the same address 000, and similarly the print data to be printed in the next column is in turn retained in the address 000 in the lateral direction. The print data of nozzle number 127 is retained in address 0FE.

In this way, the data of the same nozzle number is retained in the same address of the RAM 203 or HDD 204. However, the data of b0 from address 000 to address 0FE is actually retained as the first column, and the data of b1 from address 000 to address 0FE is retained as the second column. Therefore a horizontal-vertical conversion circuit performs horizontal-vertical conversion to the print data stored in the RAM 203 or HDD 204 in the raster direction, and the print data is stored in the second print memory 211 in the column direction.

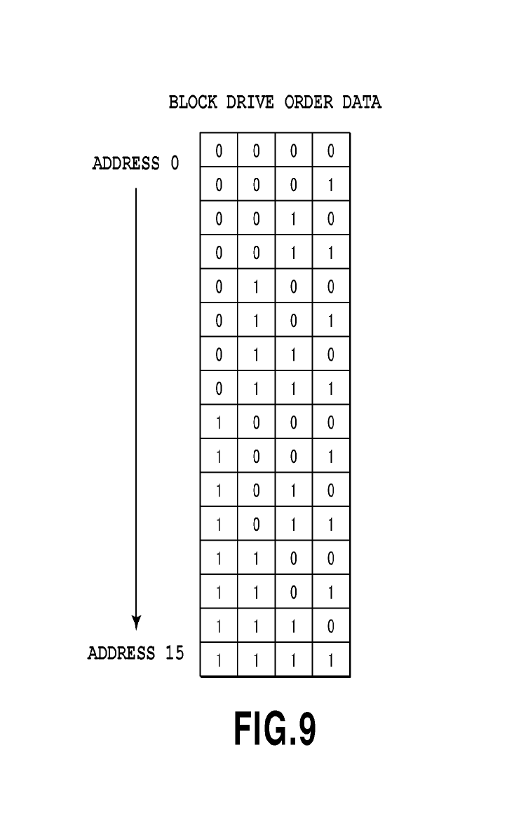

FIG. 9 shows an example of block drive order data written in address 0 to address 15 of the block drive order data memory 214. In this figure, block data showing block 0 and block 1 respectively is stored in address 0 and address 1 of the block drive order data memory 214. Similarly block data showing block 2 to block 15 is in turn stored in address 2 to address 15 of the block drive order data memory 214.

The data selection circuit 215 shown in FIG. 6 reads out block data 0000 (hereinafter, a numerical value indicating block 0) as a block enable signal from address 0 in the block drive order data memory 214 in response to a print timing signal as a trigger. The data selection circuit 215 reads out the print data corresponding to this block data 0000 from the third print memory 213 and transfers this print data to the print head 4a.

The data selection circuit 215 reads out block data 0001 (hereinafter, a numerical value indicating block 1) as a block enable signal from address 1 in the block drive order data memory 214 in response to the next print timing signal as a trigger. The data selection circuit 215 reads out the print data corresponding to this block data 0001 from the third print memory 213 and transfers this print data to the print head 4a.

Similarly the data selection circuit 215 reads out block data in turn from address 2 to address 15 in the block drive order data memory 214 in response to the next print timing signal as a trigger. The data selection circuit 215 reads out the print data corresponding to each block data from the third print memory 213, and transfers the print data to the print head 4a.

In this way, the data selection circuit 215 reads out the block data set from address 0 to address 15 in the block drive order data memory 214. The data selection circuit 215 reads out the print data corresponding to each block data from the third print memory 213 and transfers this print data to the print head 4a. Thus a print of one column is performed.

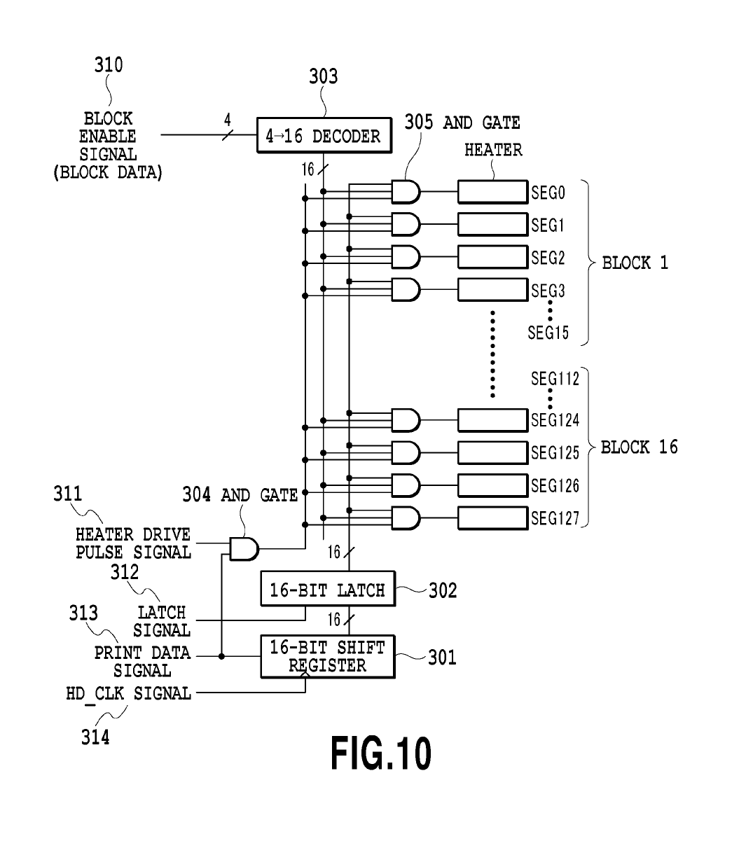

FIG. 10 is a drive circuit diagram for driving the print heads 4a to 4d, which divide 128 pieces of nozzles 18 into 16 blocks for the driving, and drive 16 pieces of the nozzles 18 assigned to the same block.

A print data signal 313 is sent to the print heads 4a to 4d in response to an HD_CLK signal 314 by a serial transfer. After the print data signal 13 is received in a shift resistor 301 of 16 bits, it is latched by a latch 302 of 16 bits at a rise of a latch signal 312. Designation of the block is shown in four block enable signals 310, and the nozzle 18 of the designation block developed by a decoder 303 is selected.

Only the nozzle 18 designated by both of the block enable signal 310 and the print data signal 313 is driven by a heater drive pulse signal 311 passing through an AND gate 305 to eject ink droplets, thus performing an image print.

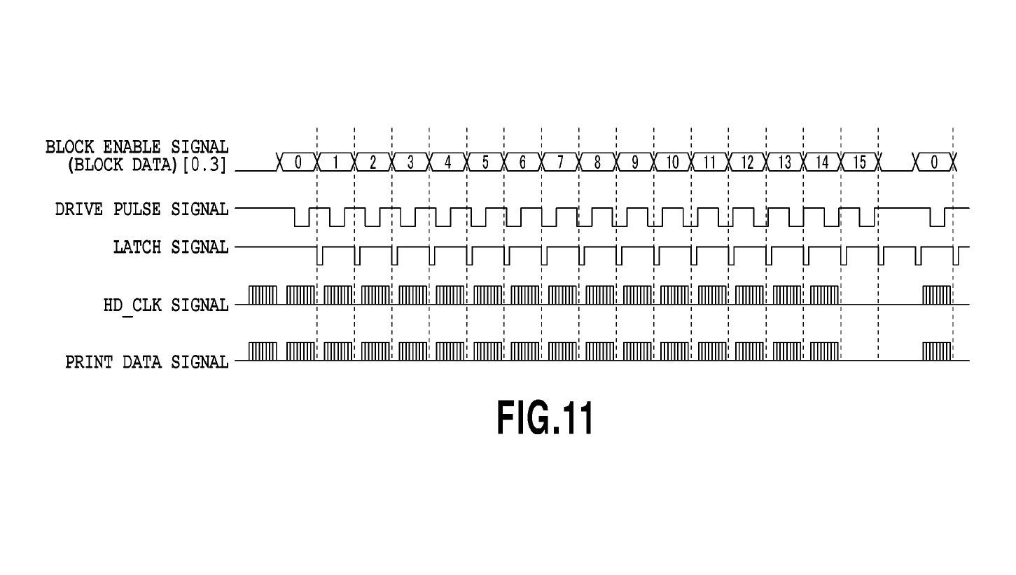

FIG. 11 shows drive timing of the block enable signal 310. The block enable signal 310 can be generated based upon the block drive order data stored in the block drive order data memory 214 in the division block selection circuit.

Therefore, as shown in the block enable signal 310 of this figure, in the division block selection circuit the block drive order generated by the block drive order data memory 214 is set by designating 16 blocks from block 0 to block 15 in turn. Therefore in a one-way direction print and in a forward scan print in a both-way direction print, the block enable signal 310 showing the drive timing drives the print heads 4a to 4d in the drive order of block 0→1→2→ . . . →15. It should be noted that the block enable signal 310 is generated in such a manner that each block is designated at timing of an equal interval in one cycle.

### <Print Data>

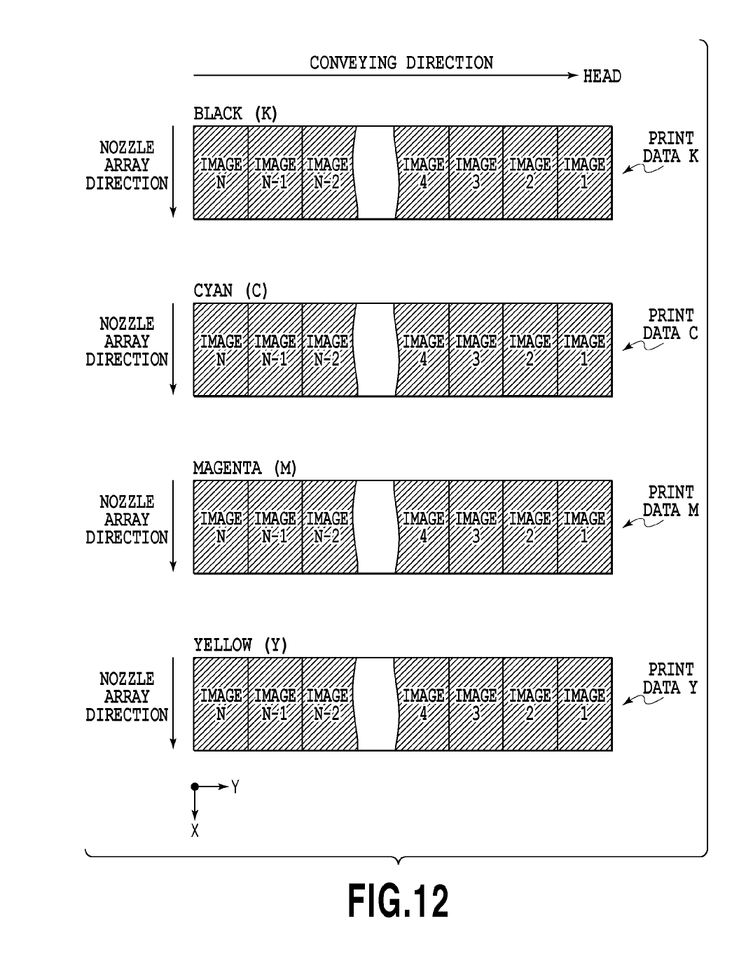

FIG. 12 is pattern diagrams each showing the arrangement of images to be printed by each of the print heads 4a to 4d, and each of print data K to Y is configured of print data to be printed by each of the print heads 4a to 4d. This print data is data found by executing a predetermined image process to image data for quantization, wherein a print (1) or non-print (0) of a dot to an individual pixel is defined.

As shown in this figure, in any print head images are printed in the order of image 1 to image N shown in the figure, and as explained in FIG. 3, the images are printed in the order of the print heads 4a to 4d. That is, after printing image 1 by the print head 4a, a print of image 1 by the print head 4b, a print of image 1 by the print head 4c, and a print of image 1 by the print head 4d are performed in that order to complete the print of image 1. It should be noted that in FIG. 12, a non-image area between image areas is omitted.

The CPU 201 reads out the print data that is processed by the image processing unit 207 and is stored in the RAM 203 or the HDD 204, and sends this print data to the engine control unit 208, by control of the engine control unit 208 an image corresponding to each of the print heads 4a to 4d is printed.

<Case where Null Data is in Advance Added to Print Data>

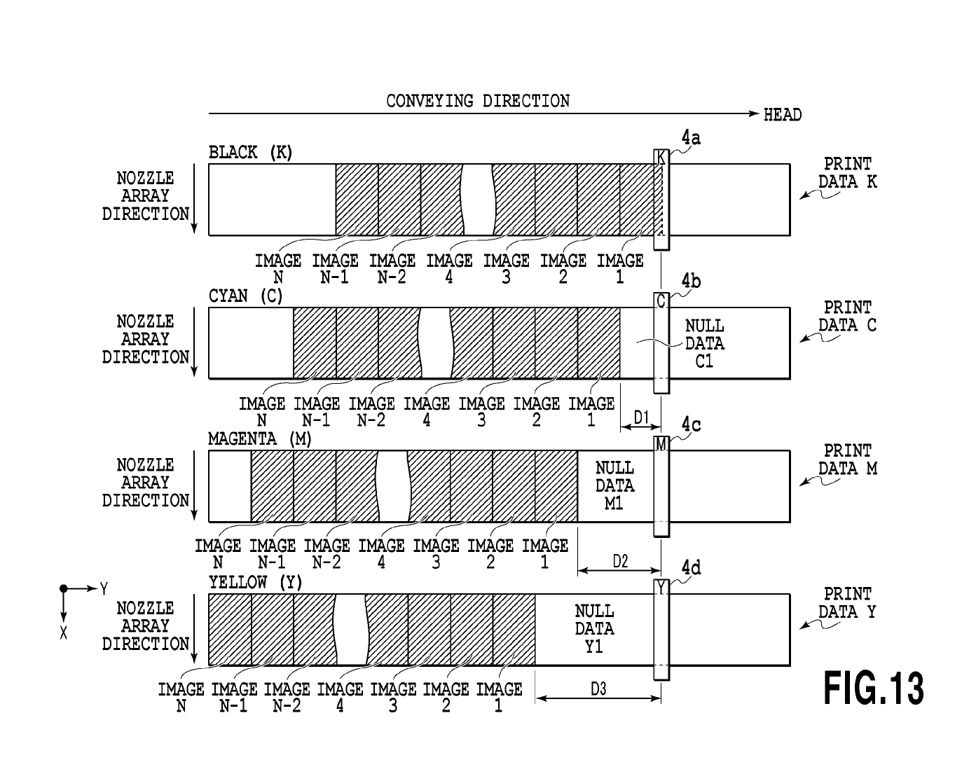

FIG. 13 is pattern diagrams each showing print data of each of the print heads 4a to 4d, to which null data is in advance added. As shown in this figure, null data C1 to Y1 each having the line number corresponding to each of distances D1 to D3 explained in FIG. 3 is respectively added to a position ahead of image 1 of each of the print heads 4a to 4d. Here, one line means an area printed by one time of an ejection operation by one nozzle array, and an area having a width of one pixel along the width direction of the print medium 3. The addition of the null data to the print data is performed in the CPU 201.

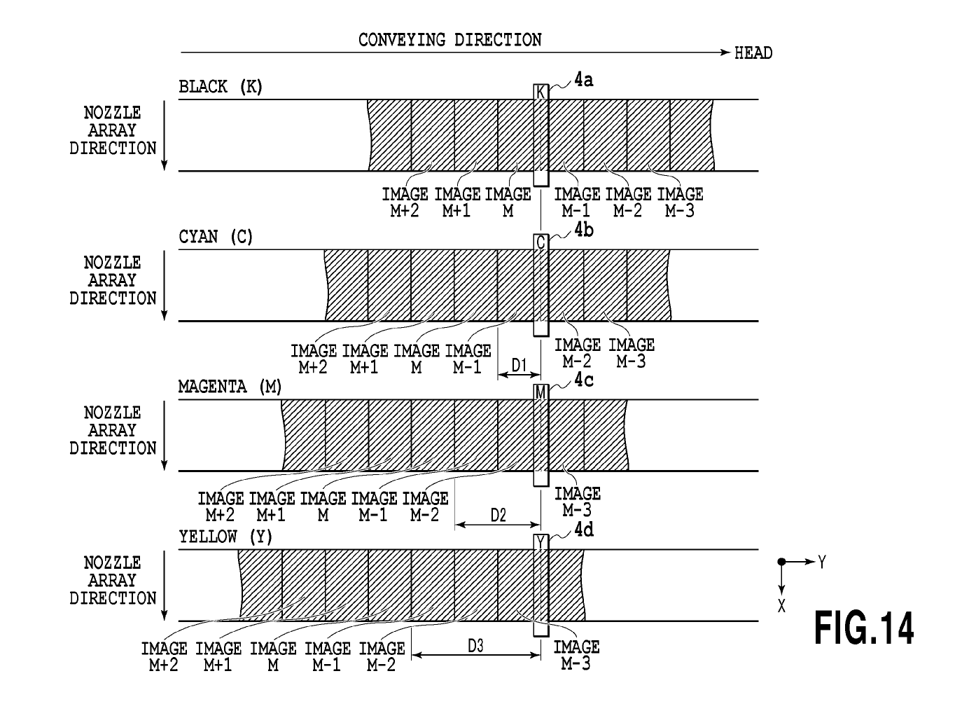

FIG. 14 is pattern diagrams each showing print timing of the print data shown in FIG. 13, and in detail, is diagrams each diagrammatically showing timing for printing image M shown in this figure. In this figure, a conveying amount of the print medium 3 is a desired conveying amount.

As shown in FIG. 13, null data C1 having the line number corresponding to distance D1 is added to print data C of the print head 4b ahead of image M. Therefore by adjusting a print position displacement between the print heads 4a and 4b by null data C1, as shown in FIG. 14 a print of image M can start from a point where distance D1 is interposed from a print start position of image M−1 ahead of image M.

Similarly as explained in FIG. 13, null data M1 having the line number corresponding to distance D2 is added to print data M of the print head 4c ahead of image M. Therefore as shown in FIG. 14, a print position displacement between the print heads 4a and 4c can be adjusted by null data M1.

Also in the print head 4d, as explained in FIG. 13, null data Y1 having the line number corresponding to distance D3 is added to print data Y ahead of image M. Therefore as shown in FIG. 14, a print position displacement between the print heads 4a and 4d can be adjusted by null data Y1.

In a case shown in FIG. 14, as shown in FIG. 13 null data C1 to Y1 respectively is in advance added to print data C to Y, and thereby the print start position of the image of each of the print heads 4a to 4d can be made in agreement. In addition, in a case shown in FIG. 14, since a conveying amount of the print medium 3 is a desired conveying amount, the print position displacement to be generated in a case where the conveying amount changes is not generated. In this way, in a case where the conveying amount of the print medium 3 is the desired conveying amount, the print start position of the nozzle array in each of the print heads 4a to 4d can be adjusted by in advance adding null data C1 to Y1 each having the line number corresponding to each of distances D1 to D3 to each of print data C to Y.

As described above, in a case where the conveying amount of the print medium 3 does not vary, the predetermined null data is in advance applied to the print data, and thereby the ejection timing of ink between nozzle arrays is adjusted, thus making it possible to coordinate with the print position on the print medium. However, there are some cases where the conveying amount of the print medium 3 varies. Therefore even if the null data is in advance added to the head of the print data, when the conveying amount of the print medium 3 varies, the print position on the print medium 3 is displaced.

There is the next method as a method for correcting the print position displacement. That is, the detection pattern is printed on a non-image area in the middle of performing a print on the print medium 3, and this detection pattern is read by the inspection unit 6. The inspection unit sends the read information to the controller 17. The controller 17 finds a print position displacement amount based upon the information obtained from the inspection unit 6, and adds adjustment data (non-image data/null data) of a line number (pixel number) corresponding to this displacement amount between images of each print head as an adjustment pattern. Hereinafter, a method for correcting the print position displacement according to this method will be explained.

<Case where a Conveying Amount is Shorter than a Desired Conveying Amount>

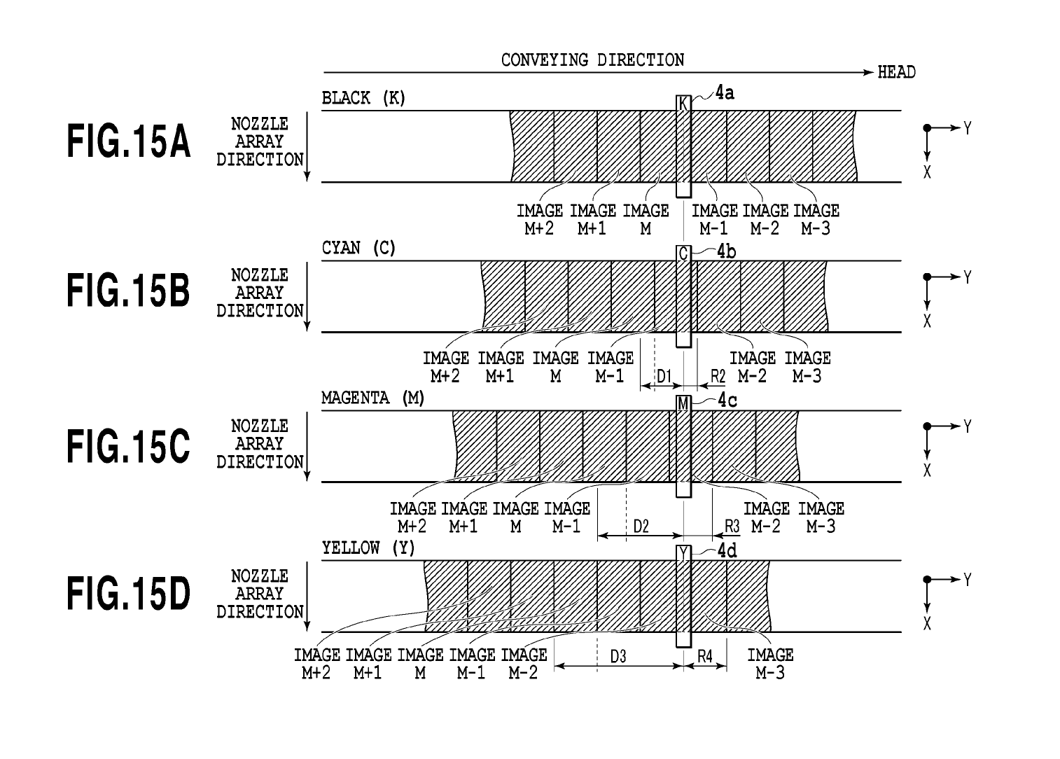

First, a case where a conveying amount of the print medium 3 is shorter than a desired conveying amount will be explained. FIG. 15A to FIG. 15D are pattern diagrams each showing print timing in a case where the conveying amount of the print medium 3 is shorter as compared to a case shown in FIG. 14.

In a case where the conveying amount is a desired conveying amount, the print head 4b starts with a print of image M−1 at timing where the print head 4a starts with a print of the head in image M (refer to FIG. 14). However, in a case where the conveying amount of the print medium 3 is shorter than the desired conveying amount, the head of image M−1 printed by the print head 4a is positioned upstream of the position of the print head 4b at timing where the print head 4a starts with a print of the head in image M.

At timing where the head of image M−1 printed by the print head 4a is actually arranged in the print position of the print head 4b, as shown in FIG. 15B the print head 4b has already printed image M−1 by R2 line. Similarly at timing where the head of image M−2 printed by the print head 4a is actually arranged in the print position of the print head 4c, as shown in FIG. 15C the print head 4c has already printed image M−2 by R3 line.

In addition, at timing where the head of image M−3 printed by the print head 4a is actually arranged in the print position of the print head 4d, as shown in FIG. 15D the print head 4d has already printed image M−3 by R4 line.

As shown in FIG. 15A to FIG. 15D, in a case where the conveying amount of the print medium 3 is shorter than the desired conveying amount, in the print heads 4b to 4d image M is printed from a position ahead of the desired print start position of image M. Therefore at the time of printing image M by the print head 4b, image M by the print head 4b is printed on part of image M−1 printed prior to image M by the print head 4a. Such a displacement of the print position is likewise generated in the print head 4c, and in the print head 4d, image M is printed on part where image M−1 is printed by the print head 4a.

Even if such a displacement of the print position is generated, the displacement of the print position can be corrected by adding adjustment data (null data) as an adjusting pattern to the print data to adjust the print position.

Specifically, as described above the detection pattern printed by the printing unit 5 is read by the inspection unit 6 to measure a displacement amount of the print position, and the adjustment data is added to the print data of each print head to correct the position displacement. In addition, in a case where the conveying amount is shorter than the predetermined conveying amount as in the present example, as the print head is positioned in the farther downstream side, the line number of the adjustment data (null data) added ahead of image M is made the larger. Thereby the print timing of image M is delayed. By doing so, the print start position of each of all the print heads is adjusted.

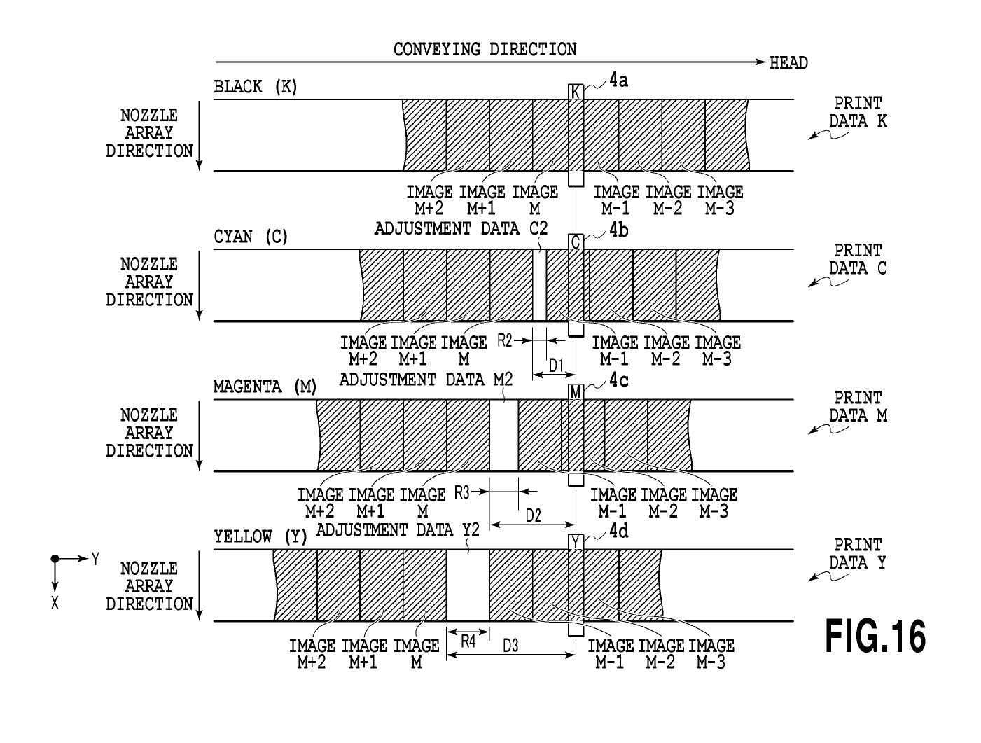

This method will be explained with reference to FIG. 16. FIG. 16 are pattern diagrams each showing a case where the state shown in each of FIG. 15A to FIG. 15D is corrected to make the print positions of image M by the four print heads be in agreement. In a case where the conveying amount of the print medium 3 is determined to be shorter than the desired conveying amount, the CPU 201 applies adjustment data C2 to Y2 respectively to print data C to Y of the print heads 4b to 4d where the displacement of the print position is generated.

As shown in this figure, adjustment data C2 corresponding to R2 line is added between image M−1 and image M in the print head 4b, adjustment data M2 corresponding to R3 line is added between image M−1 and image M in the print head 4c, and adjustment data Y2 corresponding to R4 line is added between image M−1 and image M in the print head 4d. Line number R3 of adjustment data M2 is set more than line number R2 of adjustment data C2, and line number R4 of adjustment data Y2 is set more than line number R3 of adjustment data M2.

In this way, since the print start positions of the respective print heads can be made in agreement on the print medium in image M by adding adjustment data C2 to Y2, it is possible to correct the displacement of the print position.

<Case where a Conveying Amount is Longer than a Desired Conveying Amount>

As described above, in this method the adjustment data (null data) having the line number in which the position displacement can be corrected is added to the print data of each of the print heads, and thereby the displacement of the print position is corrected. In a case where the CPU 201 determines that the conveying amount of the print medium 3 is longer than a desired conveying amount, the CPU 201 adds adjustment data K3 to M3 respectively to print data K to M of the print heads 4a to 4c. Since the print start positions of image M in the print heads 4a to 4d can be made in agreement on the print medium by adding adjustment data K3 to M3 to print data K to M, it is possible to correct the displacement of the print position.

In this method, in a case where the conveying amount of the print medium 3 is shorter than the desired conveying amount, the line number of the adjustment data added to the print data of the print head positioned in the downstream side of the conveying direction is made more than the line number of the adjustment data added to the print data of the print head positioned in the upstream side of the conveying direction. On the other hand, in a case where the conveying amount of the print medium 3 is longer than the desired conveying amount, the line number of the adjustment data added to the print data of the print head positioned in the upstream side of the conveying direction is made more than the line number of the adjustment data added to the print data of the print head positioned in the downstream side of the conveying direction.

According to this method, since the print start positions of the respective print heads can be made in agreement on the print medium by increasing/decreasing the line number for adding the adjustment data (null data) as the adjusting pattern as needed, it is possible to correct the print position displacement between the respective print heads (the respective nozzle arrays). In addition, the print position displacement to the print position of a print element array as a reference among a plurality of print element arrays can be adjusted by a pixel number of the adjusting pattern added to the print data other than the print element array as the reference. At this time, a correction value of the print element array as the reference among the plurality of the print element arrays may be fixed, and a correction value of the print element array other than the print element array as the reference may be changed.

According to the method as described above, since the print position of each of the print heads is adjusted by the line number (pixel number) of the adjustment data added to the print data, the print position displacement in one pixel unit can be corrected, but the print position displacement in less than one pixel can not be corrected. Therefore hereinafter, a method for correcting the print position displacement in less than one pixel will be explained.

FIG. 17A is a pattern diagram showing images and non-images on the print medium, and FIG. 17B is a pattern diagram showing the arrangement of dots. It should be noted that FIG. 17B is an enlarged diagram of area A shown in FIG. 17A.

As shown in FIG. 17A, the image and the non-image are printed alternately on the print medium 3 in the present embodiment. That is, as shown in FIG. 17A, non-image 1, image 1, non-image 2 and image 2 are printed in that order from the downstream side in the conveying direction of the print medium 3. As a result, the image area and the non-image area (null data) are alternately arranged in the print data of each of the print heads 4a to 4d.

In the present embodiment, a solid image is printed on an image area. FIG. 17B shows the arrangement of dots for printing solid images alternately by black ink and yellow ink. It should be noted that the filled dots in FIG. 17B show dots printed by black ink, and the other dots show dots printed by yellow ink. The numerical number attached in the dot shows the block number of a nozzle for applying the dot.

As shown in FIG. 17B, in area A shown in FIG. 17A, dots of black ink and dots of yellow ink are alternately arranged by three pixels respectively by 16 pieces of nozzles (block numbers 0 to 15) belonging to the same group in the nozzle array. In addition, in FIG. 17B the dots by 16 pieces of the nozzles are formed in the same column (area of one pixel width). In FIG. 17B, the dots formed by a drive of one cycle of block numbers 0 to 15 of nozzles are formed in the same column, and a state where the print position displacement is not generated is shown.

A correction method of a case where dots are formed from a position (desired position) where the print position displacement is not generated to a position where the print position is displaced by one-half of a pixel, will be explained below.

<Case where Dots are Displaced by One-Half of a Pixel Toward the Downstream Side of the Conveying Direction>

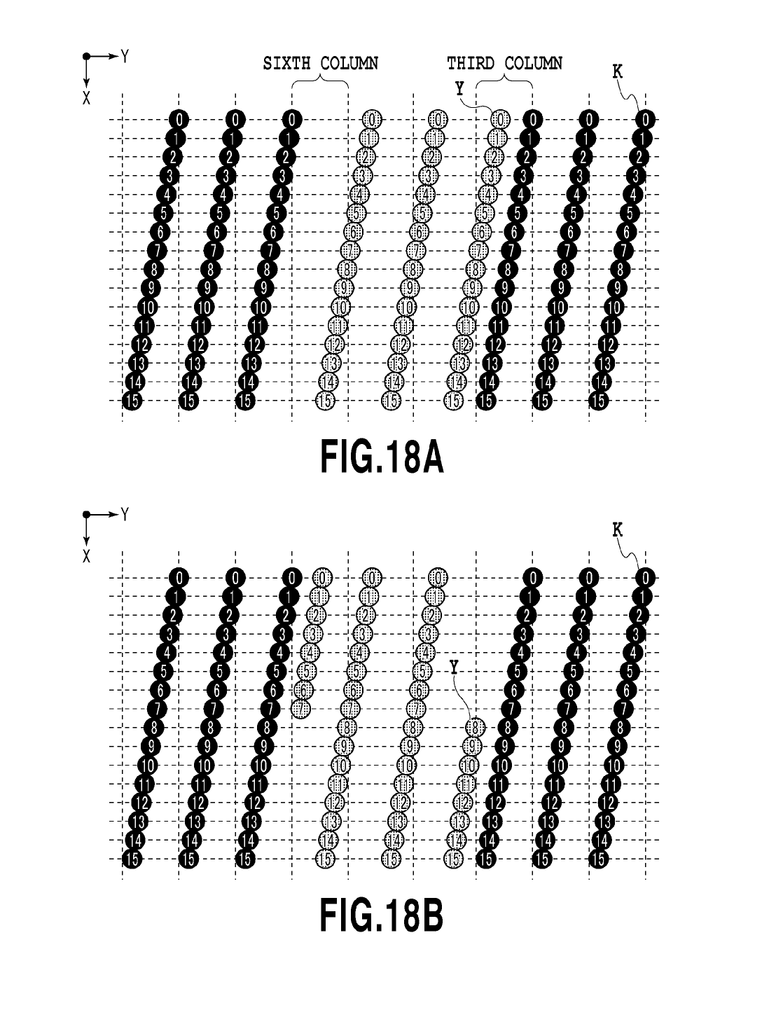

FIG. 18A is a pattern diagram showing the arrangement of dots in a case where dots by yellow ink are printed earlier by one-half of a pixel than in a state shown in FIG. 17B, and FIG. 18 B is a pattern diagram showing the arrangement of dots in a state in which the state shown in FIG. 18A is corrected.

As shown in FIG. 18A, dots by black ink are formed in the same positions as in a case shown in FIG. 17B, but dots by yellow ink are formed earlier by one-half of a pixel than in a case shown FIG. 17B.

As shown in FIG. 18A, in the third column, dots formed by nozzles 18 having block numbers 0 to 15 of black ink and dots formed by nozzles 18 having block numbers 0 to 7 of yellow ink are arranged in the same column. In addition, in the sixth column, only dots formed by nozzles 18 having block numbers 8 to 15 of yellow ink are arranged.

In a case where this print position displacement is detected by measuring the detection pattern printed on the non-image area, in the present embodiment the storage position of the print data of the nozzles 18 having block numbers 0 to 7 is shifted by one pixel in the upstream side in the conveying direction of the print medium 3 for correcting the print position displacement. In other words, the block number that can be accommodated in the same column by shifting the storage position by one pixel is selected, and the storage position of the print data of the nozzles is shifted by one pixel in the upstream side of the conveying direction.

As described above, since the image and the non-image of the print data are alternately arranged in the present embodiment, the storage position of the print data for the nozzles 18 having block numbers 0 to 7 is changed on the non-image area. By doing so, without changing the pixel number on the image area, it is possible to prevent degradation in image quality due to changing the storage position of the print data on the continuous image area, and it is possible to correct the print position displacement.

By thus correcting the displacement, as shown in FIG. 18B, since the dots formed by the nozzles 18 having block numbers 0 to 15 of yellow ink can be formed in the same column, the print position displacement can be corrected.

<Case where Dots are Displaced by One-Half of a Pixel Toward the Upstream Side of the Conveying Direction>

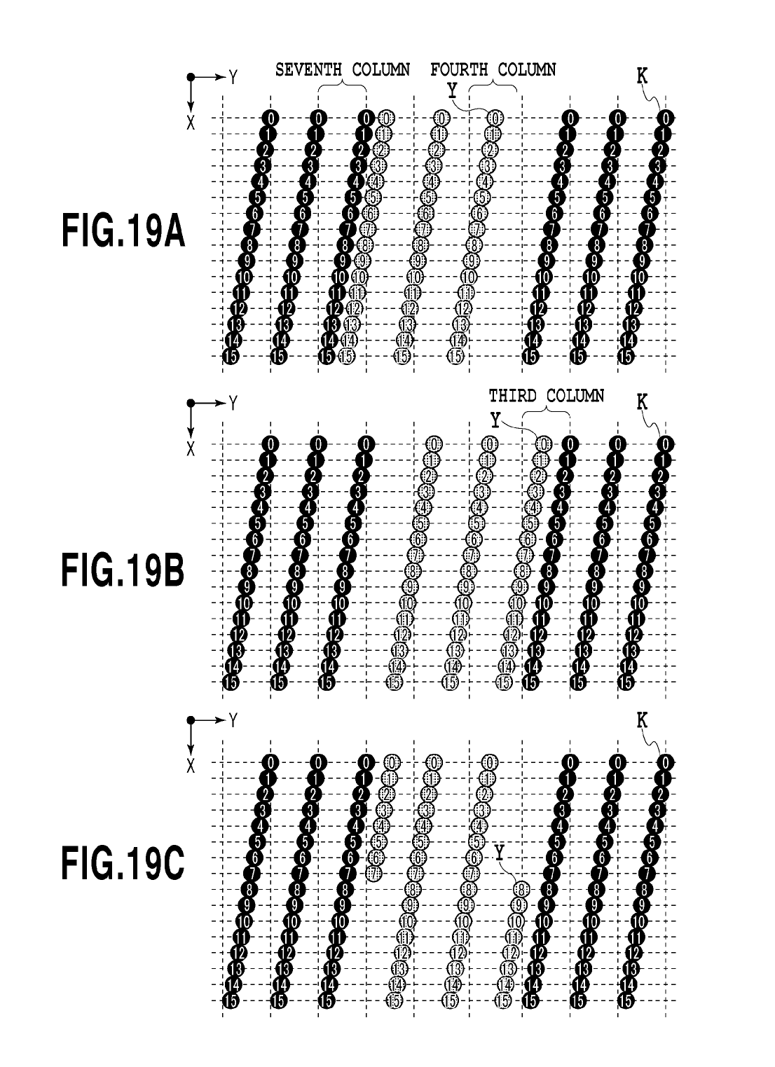

FIG. 19A is a pattern diagram showing the arrangement of dots in a case where dots by yellow ink are printed later by one-half of a pixel than in a state shown in FIG. 17B. FIG. 19B is a pattern diagram showing the arrangement of dots in the process of correcting the state shown in FIG. 19A, and FIG. 19C is a pattern diagram showing the arrangement of dots in a state of correcting the state shown in FIG. 19A.

As shown in FIG. 19A, dots by black ink are formed in the same positions as in a case shown in FIG. 17B, and dots by yellow ink are formed later by one-half of a pixel than in a case shown FIG. 17B. That is, as shown in FIG. 19A, in the fourth column, dots by yellow ink are formed by only nozzles 18 having block numbers 0 to 7. In the seventh column where dots by 16 pieces of nozzles 18 of black ink are formed, dots formed by nozzles 18 having block numbers 8 to 15 of yellow ink are also arranged.

In a case where this print position displacement is detected by measuring the detection pattern printed on the non-image area, it is considered that the storage position of the print data of the nozzles 18 having block numbers 8 to 15 is shifted by one pixel to the downstream side in the conveying direction of the print medium 3 for correcting the print position displacement. However, it is desired to shift the storage position of the print data of the nozzles to the upstream side in the conveying direction in view of the configuration of the print head. Therefore in the present embodiment, as shown in FIG. 19B, after the dots are arranged in the same arrangement as in FIG. 18A which is the state where the dots are displaced by one-half of a pixel toward the downstream side of the conveying direction, as shown in FIG. 19C the same process as the above-mentioned process explained using FIG. 18B is executed.

FIG. 19B shows a state where the dots by yellow ink shown in FIG. 19A are displaced by one pixel toward the downstream side of the conveying direction of the print medium 3. As described above, in print data K to Y of the respective print heads 4a to 4d, the image and the non-image are alternately arranged. Since the print data is arranged in this way, in the present embodiment, the line number (pixel number) on the non-image area (null data, that is, adjustment data) before the image where the print position displacement is corrected is reduced by one line (one pixel).

By doing so, as shown in FIG. 19B, the arrangement of the dots of yellow ink formed later by one-half of a pixel shown in FIG. 19A is made to the same arrangement as the arrangement of the dots in a case of being formed earlier by one-half of a pixel shown in FIG. 18A. As shown in FIG. 19C, as similar to FIG. 18B, the storage position of the print data having block number 0 to 7 is shifted to the upstream side of the conveying direction by one pixel. In this way, as shown in FIG. 19C, the dots by the nozzles 18 having block numbers 0 to 15 can be formed in one column.

As described above, in the present embodiment, the correction to the print position displacement is performed using the non-image area. In a case of printing the detection pattern for each time the non-image area opposes the print head as in the case of the present embodiment, when the print position displacement is measured, the correction to the print position displacement is performed at the time of printing the subsequent detection pattern.

As described above, in the present embodiment the detection pattern is printed on the non-image area, the detection pattern is read, and in regard to the nozzles in number corresponding to the amount of the print position displacement, the pixel for the printing by the corresponding nozzles is shifted. In more detail, in a case where the print position is displaced toward the downstream side of the conveying direction of the print medium, shifts the pixels which are to be printed by the print elements the number of which corresponds to the amount of the print position displacement toward the upstream side of the conveying direction of the print medium for each block. On the other hand, in a case where the print position is displaced toward the upstream side of the conveying direction of the print medium, shifts the pixels which are to be printed by the print elements the number of which corresponds to the amount of the print position displacement toward the upstream side of the conveying direction of the print medium for each block after reducing the pixel number on the non-image area. In this way, the pixel for the printing by the nozzle is shifted to correct the print position displacement.

According to the present embodiment, the detection pattern is printed on the non-image area and the displacement amount of the print position is detected. Therefore the print position displacement can appropriately be corrected regardless of a change in conveyance accuracy of the print medium. It should be noted that in the above-mentioned explanation, the correction to the print position displacement in one pixel unit and the correction to the print position displacement in less than one pixel are separately explained. However, there are some cases where the print position displacement in one pixel unit and the print position displacement in less than one pixel occur at the same time. In this case, a correction value including a value for adjusting the number of pixels on the non-image area for each of the plurality of the print element arrays respectively and a value for shifting the pixels which are to be printed by the print elements the number of which corresponds to the amount of the print position displacement for each block may be used to correct the print position displacement.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-233790, filed Oct. 23, 2012, which is hereby incorporated by reference herein in its entirety.

What is claimed is:

1. A printing apparatus which uses a plurality of print element arrays in each of which a plurality of print elements are arranged, and drives a predetermined number of print elements of each of blocks that are obtained by dividing each of the plurality of the print element arrays into pieces of the predetermined number of the print elements respectively in a time division driving manner, to perform printing on a print medium that is conveyed, said printing apparatus comprising:
a position displacement detecting unit configured to detect print position displacements of the plurality of the print element arrays from each other; and
a correction unit configured to perform correction in which pixels which are to be printed by print elements is shifted, the number of the print elements corresponding to an amount of the print position displacement, by a block in each of the plurality of the print element arrays.

2. A printing apparatus according to claim 1, further comprising:
a unit configured to store a correction value for correcting the print position displacement, wherein
the correction value includes a value for adjusting the number of pixels on the non-image area for each of the plurality of the print element arrays respectively and a value for shifting the pixels which are to be printed by the print elements the number of which corresponds to the amount of the print position displacement for each block, and
said correction unit performs the correction according to the correction value.

3. A printing apparatus according to claim 1, wherein
said correction unit, in a case where the print position is displaced toward the downstream side of the conveying direction of the print medium, shifts the pixels which are to be printed by the print elements the number of which corresponds to the amount of the print position displacement toward the upstream side of the conveying direction of the print medium for each block, and
said correction unit, in a case where the print position is displaced toward the upstream side of the conveying direction of the print medium, shifts the pixels which are to be printed by the print elements the number of which corresponds to the amount of the print position displacement toward the upstream side of the conveying direction of the print medium for each block after reducing the pixel number on the non-image area.

4. A printing apparatus according to claim 2, wherein
said correction unit fixes the correction value of the print element array that is a reference among the plurality of the print element arrays, and changes the correction value of the print element array other than the reference print element array.

5. A printing apparatus according to claim 1, further comprising:
a pattern printing unit configured to print a detection pattern on the print medium by using the plurality of the print element arrays, wherein
said position displacement detecting unit detects print position displacements of the plurality of the print element arrays from each other by making measurement of the detection pattern,
said correction unit performs a correction for printing after performing the detection pattern printing.

6. A printing apparatus according to claim 5, wherein
said correction unit performs the correction when said pattern printing unit prints the detection pattern after printing the previous detection pattern.

7. A printing apparatus according to claim 5, wherein
said position displacement detecting unit is positioned on downstream side of said pattern printing unit in the conveying direction of the print medium, and includes a sensor for reading in the detection pattern.

8. A printing apparatus according to claim 1, wherein
the print element includes a nozzle that can eject ink.

9. A printing apparatus according to claim 5, wherein
said pattern printing unit prints the detection pattern on a non-image area of the print medium by using the plurality of the print element arrays.

10. A printing apparatus according to claim 5, wherein
said pattern printing unit prints the detection pattern on an image area of the print medium by using the plurality of the print element arrays.

11. A method for correcting print position displacement in a printing apparatus which uses a plurality of print element arrays in each of which a plurality of print elements are arranged, and drives a predetermined number of print elements of each of blocks that are obtained by dividing each of the plurality of the print element arrays into pieces of the predetermined number of the print elements respectively in a time division driving manner, to perform printing on a print medium that is conveyed, said method comprising:
a position displacement detecting step for detecting print position displacements of the plurality of the print element arrays from each other; and
a correction step for performing correction in which pixels which are to be printed by print elements is shifted, the number of the print elements corresponding to an amount of the print position displacement, by a block in each of the plurality of the print element arrays.

12. A method for correcting print position displacement according to claim 11, further comprising:
a step for storing a correction value for correcting the print position displacement, wherein
the correction value includes a value for adjusting the number of pixels on the non-image area for each of the plurality of the print element arrays respectively and a value for shifting the pixels which are to be printed by the print elements the number of which corresponds to the amount of the print position displacement for each block, and
in said correction step, the correction is performed according to the correction value.

13. A method for correcting print position displacement according to claim 11, wherein
in said correction step, in a case where the print position is displaced toward the downstream side of the conveying direction of the print medium, shifts the pixels which are to be printed by the print elements the number of which corresponds to the amount of the print position displacement toward the upstream side of the conveying direction of the print medium for each block, and
in said correction step, in a case where the print position is displaced toward the upstream side of the conveying direction of the print medium, shifts the pixels which are to be printed by the print elements the number of which corresponds to the amount of the print position displacement toward the upstream side of the conveying direction of the print medium for each block after reducing the pixel number on the non-image area.

14. A method for correcting print position displacement according to claim 12, wherein
in said correction step, the correction value of the print element array that is a reference among the plurality of the print element arrays is fixed, and the correction value of the print element array other than the reference print element array is changed.

15. A method for correcting print position displacement according to claim 11, further comprising:
a pattern printing step for printing a detection pattern on the print medium by using the plurality of the print element arrays; wherein
in said position displacement detecting step, print position displacements of the plurality of the print element arrays from each other are detected by making measurement of the detection pattern,
in said correction step, a correction for printing after performing the detection pattern printing is performed.

16. A method for correcting print position displacement according to claim 15, wherein
the correction is performed when the detection pattern is printed after printing the previous detection pattern in said pattern printing step.

17. A method for correcting print position displacement according to claim 15, wherein
in said pattern printing step, the detection pattern is printed on a non-image area of the print medium by using the plurality of the print element arrays.

18. A method for correcting print position displacement according to claim 15, wherein
in said pattern printing step, the detection pattern is printed on an image area of the print medium by using the plurality of the print element arrays.
